(19) United States
(12) Patent Application Publication
(10) Pub. No.: US 2007/0021115 A1
(43) Pub. Date: Jan. 25, 2007

(54) Automatic distribution of capability and configuration information between mobile switching centers in a mobile communication network

(76) Inventor: Vincent Nikkelen, Budapest (HU)

Correspondence Address: ERICSSON INC., 6300 LEGACY DRIVE, M/S EVR C11, PLANO, TX, 75024, US

(21) Appl. No.: 10/595,376

(22) PCT Filed: Oct. 14, 2003
(86) PCT No.: PCT/IB03/04526

§ 371 Date: Apr. 13, 2006

(51) Int. Cl. H04Q 7/20

(52) U.S. Cl. 455/428

(57) ABSTRACT

A system and method for achieving interoperability between telecommunication servers such as Mobile Switching Centers (MSCs) in a mobile communication network by automatically distributing capability and configuration information between the MSCs. Whenever one of the MSCs is started-up, or undergoes any other procedure that changes the configuration or capabilities of the MSC, the start-up MSC automatically sends its capability and configuration information to its neighboring MSC's. The neighboring MSCs store the information and return their own information to the start-up MSC for storage. Thereafter, whenever a service is initiated, the MSCs send to each other, only service-related information that the stored capability and configuration information indicates is supported.

### FIELD OF THE INVENTION

The present invention relates to mobile communication networks. In particular, and not by way of limitation, the present invention is directed to a system and method for achieving interoperability between telecommunication servers in a mobile communication network by automatically distributing capability and configuration information between the servers.

### BACKGROUND ART

In existing mobile communication networks, interoperability between telecommunication servers such as Mobile Switching Centers (MSCs) is achieved through several procedures. First, each MSC stores/administers the capabilities of neighboring/reachable MSCs in the network. Second, each MSC transmits to receiving MSCs, all of the information needed for the features supported by the transmitting MSC. This includes information for features that are not supported by the receiving MSC. Third, newly introduced features are designed in such a way that backwards compatibility is not hampered.

There are several disadvantages of the existing procedures. Regarding network administration, the existing procedure of administering the capabilities of neighboring/reachable MSCs within each MSC utilizes a large amount of system resources. This is undesirable to network operators who must provide these resources even though the resources are not producing revenue. In addition, the procedure has a good chance of causing system failures due to human errors such as typing mistakes. For example, if an operator owns 50 MSCs in his network, and every MSC must contain capabilities information for all the other MSCs, then changing the configuration of a single MSC requires updating the 49 other MSCs with this new information.

The existing procedures also cause problems relating to bandwidth and processing capacity. Transmitting nodes currently transmit all of the information needed for the features supported by the transmitting MSC, even for features that are not supported by the receiving MSC. This is a waste of network bandwidth and processing capacity at both the transmitting and the receiving MSCs. For example, at inter-MSC handover, the anchor MSC sends BSSMAP/Radio Access Network Application Part (RANAP) Service Handover information to the target (i.e., non-anchor) MSC even though the non-anchor MSC may not support this feature. By way of further example, the anchor MSC always includes Shared Network Information (SNA), if available. In cases where the SNA is too large to fit in the BSSMAP Handover Request message, the SNA is sent in an extra BSSMAP Common ID message. These messages are sent even if the non-anchor MSC does not support this feature, or where there is no need for the information (e.g., the non-anchor MSC is not serving a shared area).

The design of newly introduced features in such a way that backwards compatibility is not hampered causes the introduction of inefficient functionality in the network. The Mobile Application Part (MAP) protocol ensures backward compatibility by initiating the MAP dialog between MSCs with the highest version supported by the initiating MSC. If the other MSC does not support this version, a fallback mechanism is utilized to downgrade to an older version of the protocol. In some cases, however, particularly in third generation systems, the proposed solutions for backward compatibility are overly complicated. In the 3rd Generation Partnership Project (3GPP), for example, for the introduction of codec negotiation over the E-interface, a complex solution has been proposed with the introduction of a new information element in order to ensure backward compatibility. The proposed solution also requires changing one of the major design principles in handover.

Another example of inefficient functionality for the sake of backward compatibility, is found in the optional function of Inter-MSC SRNS Relocation for multiple bearers. The anchor MSC first tries the function with all bearers available. If the non-anchor MSC does not support multiple bearers, the non-anchor MSC rejects the first attempt. The anchor MSC then tries again, but with only one bearer selected.

Thus, there is much inefficiency in the existing procedures for achieving interoperability between MSCs in a mobile communication network. It would be advantageous to have a system and method for achieving interoperability by automatically distributing capability and configuration information between MSCs.

### SUMMARY OF THE INVENTION

The present invention enables interoperability between MSCs by causing each MSC to send operational information such as capability and configuration information to neighboring MSCs following a reconfiguration, reset, or any other procedure that may have changed the capabilities or configuration of the affected MSC. Each neighboring MSC that supports the invention responds by sending its own capability and configuration information to the affected MSC. Thereafter, each MSC uses its knowledge of the capabilities and configuration of neighboring MSCs to send only the information that is needed to implement requested services or features.

Thus, in one aspect, the present invention is directed to a method of automatically distributing operational information between MSCs in a mobile communication network. The method includes the steps of defining for each MSC in the network, at least one neighboring MSC; performing a procedure that changes the first MSC's operational information; and upon completion of the procedure, automatically sending the first MSC's operational information from the first MSC to the first MSC's neighboring MSCs. This is followed by receiving and storing the first MSC's operational information in each of the first MSC's neighboring MSCs; and upon receiving the first MSC's operational information, sending operational information for each of the first MSC's neighboring MSCs from the neighboring MSCs to the first MSC. The operational information may include capability and configuration information.

In another aspect, the present invention is directed to a method of reducing signaling and processing requirements in a mobile communication network having a plurality of neighboring MSCs. The method includes the steps of automatically distributing operational information between the MSC's whenever an operational capability of one of the MSCs is changed; initiating a service in a first MSC; and upon initiating the service in the first MSC, sending to MSCs neighboring the first MSC, only information that the operational information stored in the first MSC indicates is supported by the neighboring MSCs.

In yet another aspect, the present invention is directed to an MSC that automatically distributes operational information for the MSC to neighboring MSCs in a mobile communication network. The MSC includes a communication signaling mechanism that automatically sends the MSC's operational information to at least one neighboring MSC upon start-up of the MSC, and receives in return, operational information for the at least one neighboring MSC. The MSC also includes means for storing the operational information for the at least one neighboring MSC. The operational information may include capability and configuration information. The MSC may also include means for initiating a service; means for determining from the stored capability and configuration information for the at least one neighboring MSC, which information related to the initiated service is supported by the at least one neighboring MSC; and means for sending to the at least one neighboring MSC, only the service-related information that is supported by the at least one neighboring MSC.

### BRIEF DESCRIPTION OF THE DRAWINGS

FIG. 1 is a simplified block diagram illustrating a plurality of MSCs in a mobile communication network in which the present invention has been implemented;

FIG. 2 is a signaling diagram illustrating the automatic exchange of capability and configuration information between MSCs in one embodiment of the present invention; and

FIG. 3 is a flow chart illustrating the steps of one embodiment of the method of the present invention.

### DETAILED DESCRIPTION OF EMBODIMENTS

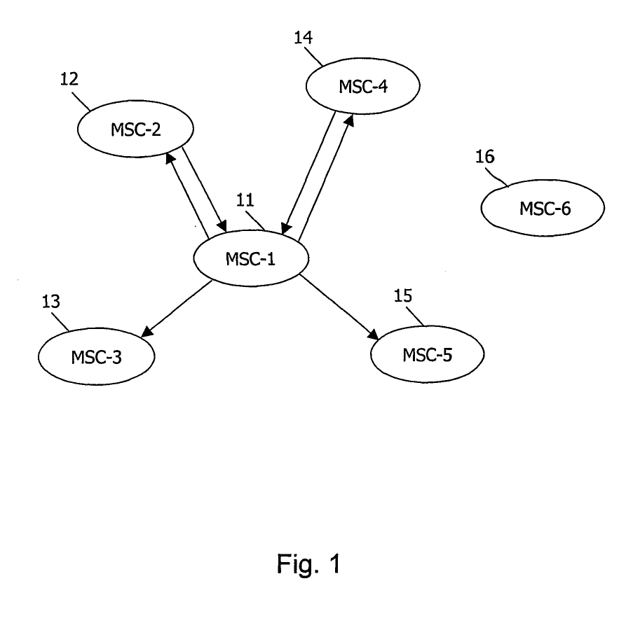

FIG. 1 is a simplified block diagram illustrating a plurality of MSCs 11-16 in a mobile communication network in which the present invention has been implemented. In the exemplary configuration illustrated, the network operator; has defined for MSC-1 that MSC-2, MSC-3, MSC-4, and MSC-5 are neighboring MSCs. MSC-6 is not a neighboring MSC. In addition, MSC-1, MSC-2, and MSC-4 support the present invention. It is not relevant to the present invention whether or not MSC-6 supports the invention because MSC-6 is not a neighboring MSC. It should also be recognized that although the exemplary embodiment described herein utilizes the term “MSC”, the invention is applicable to any telecommunication server.

In an exemplary scenario, MSC-1 is reconfigured and/or reset. Just before MSC-1 starts operation, MSC-1 sends its capability and configuration information to all of its defined neighboring MSCs. This is illustrated by the outgoing arrows from MSC-1 to MSC-2, MSC-3, MSC-4, and MSC-5. Since MSC-3 and MSC-5 do not support the present invention, they discard the information and continue to operate as before. Since MSC-2 and MSC-4 support the present invention, they store the received information and consider the information during operation. In addition, as shown by the incoming arrows to MSC-1, they send their own capability and configuration information to MSC-1.

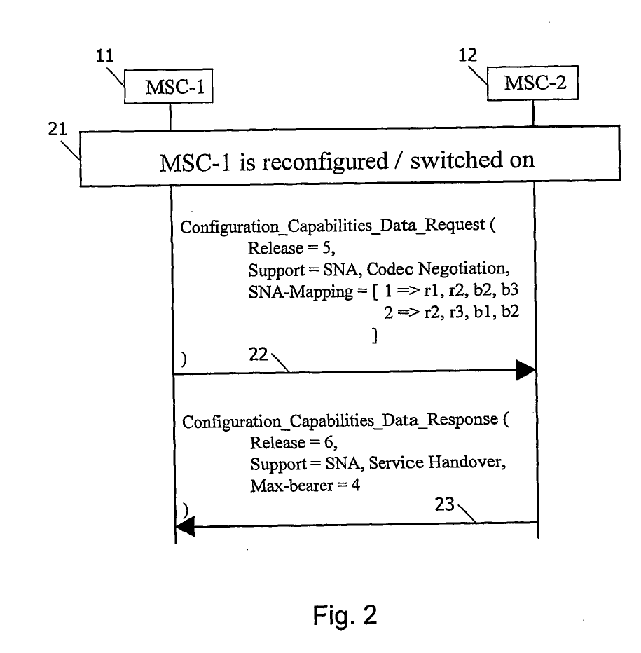

FIG. 2 is a signaling diagram illustrating the automatic exchange of capability and configuration information between MSCs in an exemplary embodiment of the present invention. It should be understood that the illustrated signaling messages and message contents are illustrative only, and that other messages, message formats, and message contents could also be utilized with the present invention. For simplicity, the interaction between only two MSCs is shown, but in reality the information is exchanged between the reset MSC and all of its defined neighbors that support the present invention.

Once MSC-1 is reconfigured or switched on at step 21, MSC-1 sends a message such as a Configuration Capabilities Data Request message 22 to neighboring MSC-2. In the exemplary message shown, MSC-1 indicates that it is compliant with the Third Generation Partnership Project (3GPP) release version 5 specification, it supports Shared Network Information (SNA), and it includes codec negotiation functionality. In addition, the message contains an indication of the SNA-information mapping utilized by MSC-1. This mapping enables MSC-1 to use a single value in communication with MSC-2 instead of a large amount of data (for example, the value 1 instead of r1, r2, b2, and b3; or the value 2 instead of r2, r3, b1, and b2).

Once MSC-2 receives the Configuration Capabilities Data Request message 22, MSC-2 stores the included information, and uses the information to make future operations more efficient. For example, MSC-2 will never send Service Handover information to MSC-1 because MSC-2 knows that MSC-1 does not support this information. In this manner, the invention saves both processing and signaling resources. In addition, MSC-2 prepares a response in the form of a Configuration Capabilities Data Response message 23. This message includes capability and configuration information for MSC-2. In the exemplary message shown, MSC-2 indicates that it is compliant with the 3GPP R6 specification, it supports SNA and Service Handover, and it can handle a maximum of four bearers. Upon receipt of the Configuration Capabilities Data Response message, MSC-1 stores the included information, and uses the information to make future operations more efficient.

Other capability and configuration data may also be included in the Configuration Capabilities Data Request message 22 and the Configuration Capabilities Data Response message 23. For example, proprietary information such as vendor identifications and vendor-specific features may also be indicated. Additionally, the messages may indicate exceptions to levels of functionality that are indicated. For example, if MSC-2 is compliant with 3GPP release version 6 except for one feature or capability, MSC-2 may indicate in its message that MSC-2 is compliant with 3GPP release version 6, but not the non-supported feature or capability.

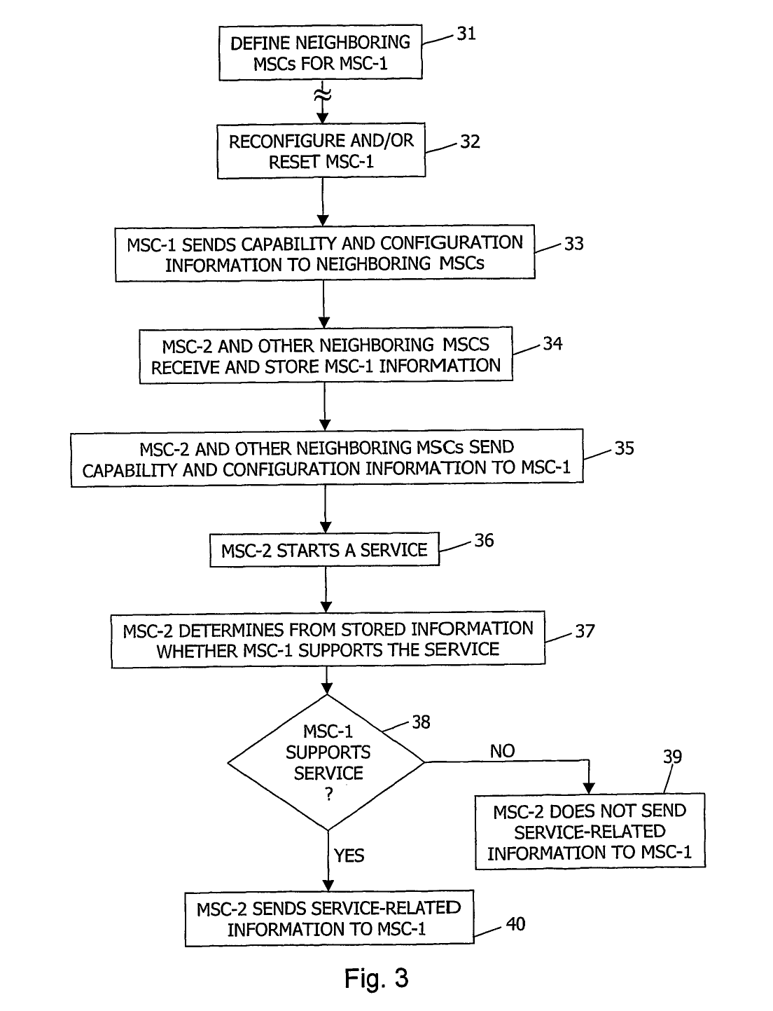

FIG. 3 is a flow chart illustrating the steps of one embodiment of the method of the present invention. At step 31, the neighboring MSCs for MSC-1 are defined. At some later time, as shown at step 32, MSC-1 may be reconfigured and/or reset. At step 33, following the reconfiguration/reset, MSC-1 sends its capability and configuration information to its neighboring MSCs. At step 34, the neighboring MSCs including, for example MSC-2, receive and store the MSC-1 capability and configuration information. At step 35, MSC-2 and the other neighboring MSCs send their own capability and configuration information to MSC-1.

At step 36, MSC-2 starts a service within the mobile communication network that requires the participation of other MSCs. At step 37, MSC-2 determines, from the capability and configuration information that it has stored for other MSCs, whether or not MSC-1 supports the service. At step 38, upon determining that MSC-1 does not support the service, the method moves to step 39 where MSC-2 does not send service-related information to MSC-1. This saves network bandwidth and relieves MSC-1 of the tasks of receiving the service-related information, analyzing the information to determine whether the information is useful, and discarding the information after determining that the information is for a service that MSC-1 does not support. However, upon determining at step 38 that MSC-1 does support the service, the method moves to step 40 where MSC-2 sends the service-related information to MSC-1. Thus, information is only sent from one MSC to another when the receiving MSC supports the service or functionality with which the information is associated.

Although the present invention has been described in detail with reference to only a few exemplary embodiments, those skilled in the art will appreciate that various modifications can be made without departing from the invention. Accordingly, the invention is defined only by the following claims, which are intended to embrace all equivalents thereof.

1-14. (canceled)

15. A method of reducing signaling and processing requirements in a mobile communication network having a plurality of defined neighboring telecommunication servers, said method comprising the steps of:
automatically distributing capability and configuration information between the servers whenever one of the servers is started up, said distributing step including:
starting-up one of the servers;
automatically sending the capability and configuration information for the start-up server, from the start-up server to defined neighboring servers;
receiving and storing the start-up server's capability and configuration information in each of the defined neighboring servers; and
upon receiving the start-up server's capability and configuration information, sending capability and configuration information for each of the defined neighboring servers from the defined neighboring servers to the start-up server; and
automatically distributing capability and configuration information from a first server to defined neighboring servers when a service is initiated in the first server, said distributing step including:
initiating the service in the first server; and
determining by the first server, whether a given defined neighboring server supports the service, based upon the capability and configuration information for the given neighboring server that the first server has received from the given defined neighboring server;
upon determining that the given neighboring server does not support the service, discarding the information; and
upon determining that the given defined neighboring server supports the service, sending from the first server to the given defined neighboring server, information relating to the initiated service.

16. The method of claim 15, wherein the telecommunication servers are Mobile Switching Centers (MSCs).

17. The method of claim 15, wherein the telecommunication servers are Mobile Switching Centers (MSCs), and the capability and configuration information sent by a given MSC includes an indication of a version of an industry standard with which the given MSC is compliant.

18. The method of claim 15, wherein the telecommunication servers are Mobile Switching Centers (MSCs), and the capability and configuration information sent by a given MSC includes an indication of a version of an industry standard with which the given MSC is compliant, together with exceptions for any capabilities of the version of the standard that are not supported by the given MSC.

19. A telecommunication server that automatically distributes capability and configuration information for the server to defined neighboring telecommunication servers in a mobile communication network, said telecommunication server comprising:
a communication signaling mechanism that automatically sends the server's capability and configuration information to at least one defined neighboring server upon start-up of the server, and receives in return, capability and configuration information for the at least one defined neighboring server;
means for storing the capability and configuration information for the at least one defined neighboring server;
means for initiating a service;
means for determining from the stored capability and configuration information for the at least one defined neighboring server, whether the initiated service is supported by the at least one defined neighboring server; and
means for sending to the at least one defined neighboring server, only the service-related information that is supported by the at least one defined neighboring server.

20. The telecommunication server of claim 19, wherein the server is a Mobile Switching Center (MSC), and the communication signaling mechanism sends the MSC's capability and configuration information to at least one defined neighboring MSC upon start-up of the MSC.

21. The telecommunication server of claim 20, wherein the communication signaling mechanism also automatically sends the MSC's capability and configuration information to the at least one defined neighboring MSC whenever the capability and configuration information of the MSC is changed.
